(19) United States
(12) Patent Application Publication
(10) Pub. No.: US 2008/0274249 A1
(43) Pub. Date: Nov. 6, 2008

(54) Nutritious corn / nutritious popcorn, nutritious peas, nutritious beans, nutritious lentils, nutritious rice, nutritious barley, nutritious oats, nutritious wheat

(76) Inventor: John Francis Hauck, Gloucester, MA (US)

Correspondence Address: John F. Hauck, 1 Dune Circle, Gloucester, MA, 01930, US

(21) Appl. No.: 11/598,715

(22) Filed: May 1, 2007

(51) Int. Cl. A23L 1/48

(52) U.S. Cl. 426/506

(57) ABSTRACT

Corn, beans, peas, soy beans, lentils, wheat, and barley (grains and legumes) have much greater nutritional value if the seeds are first germinated and, then, the germination is terminated before the root is developed.

This process of stopping the germination and preserving the nutrition in the seed will help people and livestock to grow and survive more easier and healthier, reduce starvation and malnutrition, lessen the accompanying diseases, and greatly increase the amount of healthy protein.

Process; 1. Germinate the seeds of the grains and legumes by immersing in warm water. The corn will begin to germinate in two to three days in water of about 70 degrees Fahrenheit. The other grains and legumes take less time in the warm water. Drain the water but keep the seeds moist and warm. Some of the seeds will start to develop a root. As soon as root development in some seeds is obvious it means that the rest of the seeds have reached their peak nutritional value—right before the root emerges.

2. STOP further germination by either immersing in very cold water and/or drying very quickly. I used cold water from the refrigerator with ice cubes floating on top because the seeds could be chilled very quickly and thoroughly. For drying, I used pans in the oven at a warm temperature.

3. This cooling and/or drying preserves the nutrition in the seed—nutrition is not wasted in root development.

4. This naturally enriched food could be cooked immediately for the dinner table or fed to cattle, hogs, and chickens.

5. If it is not for immediate use, the seeds should be dried as quickly as possible and stored in a cool, dry place. Once dried, the nutritious germinated grains and legumes could be saved for the family table or fed to animals whenever it is needed.

1. I claim the process of stopping the germination of grains and legumes so that the nutritional value is greatly increased and remains in the seed in order to benefit people and livestock. This is a similar process discovered by Japanese scientists specifically for brown rice.
I claim that I am the only and first and original inventor of the subject matter which is claimed and that I reviewed and understand the contents and the claims referred to in the oath of declaration.
